(19) United States
(12) Patent Application Publication
(10) Pub. No.: US 2001/0027436 A1
(43) Pub. Date: Oct. 4, 2001

(54) On-line market environment (OLME)

(76) Inventor: Samuel Sergio Tenembaum, New York, NY (US)

Correspondence Address: SAMUEL SERGIO TENEMBAUM, c/o 34 EAST 67th STREET, New York, NY, 10021, US

(21) Appl. No.: 09/778,573

(22) Filed: Feb. 8, 2001

Related U.S. Application Data
(60) Provisional application No. 60/181,185, filed on Feb. 9, 2000.

(51) Int. Cl. G06F 17/60

(52) U.S. Cl. 705/38

(57) ABSTRACT

A new method of conducting loan transactions which features a Web-based community of reversed credit auctions where Borrowers present their credit needs and collaterals and Lenders analyze those projects on a caveat emptor basis and compete through the interest rates. This method, being a Consumers to Business direct model will reduce the Borrower's costs and increase Lenders' returns.

This application claims the benefit of U.S. Provisional application Ser. No. 60/181,185 filed in the U.S. Patent and Trademark Office on Feb. 9, 2000; the entire contents of the a.m Provisional Application being hereby incorporated by reference.

### FIELD OF THE INVENTION

The present invention relates generally to a new kind of business environment where lenders and borrowers can easily meet without the presence of unnecessary mediating factors, and more particularly relates to a business method to implement this kind of On-line Loan Market Environment.

### BACKGROUND

The use of loans is perhaps the most important driving force of our economy. The underlying idea is simple: Not all the people or entities who have a temporary surplus of funds necessarily have a way to spend or invest that surplus in their own businesses. On the other hand, not all the people or entities who need funds to spend or invest in their own endeavours, necessarily have the required funds to do so. Thus, it is only natural that a huge credit market has developed to meet the needs and wants of lenders and borrowers alike. It is quite understandable that due to the complexity and delicate nature of this business, the smooth operation of these markets require the existence of various mediating factors in the form of financial institutions which end-up making handsom profits in the process. In other words, lenders give up precious percentage points in favour of the financial institutions, whereas borrowers pay higher interests for the loans they get, than the interest they would have paid if the loan transaction had been made directly between lender an borrower.

What our business method contemplates is using the Internet as a dynamic loan market arena where lenders and borrowers can meet and carry on with their transactions in a safe and protective environment, while enjoying optimal interest rates.

### SUMMARY

A need exists for a more innovative approach to correct two main loan market inefficiencies:

Limited Access: The current financial system in the US and in the world at large allows only Banks and/or similar financial institutions to offer short or mid term financial loans, leaving aside individual investors.

High costs: The high financial spreads reflect both the banking operational costs as well as the loan portfolio performance.

The essence of our invention is to provide the means through which all investors can access this market.

The individual analysis of each operation and involved risk will allow the parties to price it effectively, without the burden and benefits of the bank's portfolio approach.

Operational costs will be reduced thanks to cutting edge Internet technologies, including digital signature.

The present model will reduce Borrowers' costs and increase Lenders' returns. The underlying business concept can be summarized as follows:

Our invention is an Internet initiative designed to become an efficient alternative to the traditional US credit market, presently estimated at around U$S 25 trillion and to the international markets at large. Our business model contemplates the establishment of an online C2B (what we believe to be the first consumer-to-business site ever devised) loan market environment in which, lenders and borrowers can freely compete for loans, thus resulting in a better access for all parties involved, higher returns for investors and lower financial spreads as compared to existing markets. The applicable business method will be the Caveat Emptor Reversed Auction, where Borrowers present their credit needs (hereinafter referred to as the “Insertion”) and the quality of their financial backup (referred to as the “Project”), whereas the Lenders compete for the requested loans through the interest rates, after evaluating those projects on a caveat emptor basis and compete through the interest rates.

Our invention differentiates from other existing models, particularly as far as the following features are concerned:

Universality: Unlike existing Internet models, ours will be open to individual lenders.

Fractionability: Split options will allow small investors to participate in large deals.

Support services: Our method contemplates the creation of a trading arena that will facilitate the process by combining Internet technologies with a series of auxiliary services.

In order to promote competition our model turns around the traditional approach to credit, in which the lenders lead the process by imposing their conditions on borrowers who, in turn, passively accept them. This traditional model imposed by Banks and other professional lenders is far from ideal. The market craves for a more efficient and competitive model. Ours comes into existence to fill in this need. This process will entail a learning process on all parties involved In order to speed up this learning curve, we shall build up our foundations starting from a core that will include:

1. Quality Professional Borrowers: Corporate CFO's are already familiar with the typical professional Lenders' credit approach.

2. Standardization: Our professionally designed insertion process will be both friendly and logical and will provide close online guidance.

3. Affirmative feedback: Our site will feature comments and analysis posted by Independent Credit Analysts and Ad-hoc Brokers. In addition to this, each project will have its own discussion forum where potential lenders will have the opportunity to comment on the projects. By promoting feedback from various factors we seek to improve the quality of the insertions.

This online environment takes advantage of several factors, such as the revolutionary advances in scoring techniques, standardization of credit application formats, e-signatures and the natural edge of the Internet to gather without restrictions borrowers and lenders in an Auction Website,. The dynamics of our method will result in substantially higher returns for lenders and cost savings for borrowers.

A thorough market analysis shows that while our model will face strong competition from traditional financial market players and e-brokers, it is certainly unique in terms of universality and added value for all parties involved. Our unique selling proposition can be resumed in two key differences with other reverse auction financial sites: First, the aforementioned universality, . Secondly, unlike competing sites where the borrowers identities are kept in the dark, we believe that the borrowers' good name is one of his most precious assets, and as such, the borrower, at his own discretion, should not be prevented from using it to reduce financial costs.

Players:

1. The main players will be the Borrowers and the Lenders. Both will have to register with our online community before being able to present a project or bid for it.

2. The supporting players will be the Brokers (who will fill up the pipeline of projects and will participate in the guidance and education process), The Rating and Personal References Agencies (who will offer their credit ratings to Lenders and Guarantors alike), the Personal Referents (who will provide positive real feedback on the Borrower's credit performance), the Insurance Companies (who will offer various insurance coverage packages to the parties), Guarantors (who will collateralize the projects after signing up with our community), the Trustees (who will offer due diligence and escrow services to the parties), the Credit Analysts (who will analyze the credit risk involved in the transactions), Auditing Firms, Title Searchers, Legal Advisors and Mediation Services and the Preferred Bank.

Our marketing strategy will lean on two main pillars:

a) The creation of a loyal online community

b) The establishment of strong alliances with major supporting partners.

The revenue model contemplates the following sources:

1. Fees charged to the Borrowers

i Minimum refundable insertion fees.

ii. Relatively low success fees.

2. Fees to be charged to the Supporting Players

i. Minimum insertion fees.

ii. Commissions.

3. Advertising fees:

It is expected that our site will attract a sizable number of eyeballs, whether registered community members or general visitors. As such, the site will generate advertising revenues from selected sponsors, mainly through Shoshkeles animated ads, as well as other sophisticated advertising methods.

4. Collateral E-Commerce fees:

Our site will host E-Commerce activities that will generate commissions per every sale.

### BRIEF DESCRIPTIONS OF THE DRAWINGS

The foregoing brief description, as well as further objects, features and advantages of the present invention will be understood from the following detailed description of presently preferred embodiments, with reference being had to the accompanying drawing, in which:

FIG. 1 is a system diagram depicting the relationships between various aspects of the OLME, in accordance with the present invention;

FIG. 2 is a flowchart of an exemplary method of the registration process in the OLME in accordance with one of the embodiments of the present invention.

FIG. 3 is a flowchart of an exemplary method of the auction process in the OLME.

### DETAILED DESCRIPTION

These and other aspects of the invention will now be described in greater detail in connection with a number of exemplary embodiments.

The present invention provides a method of creating a Web-based community of reverse credit auctions where the Borrowers present their credit needs and collaterals, whereas the Lenders analyze those projects on a caveat emptor basis and compete through the interest rates they ask for the loans. As described in the previous chapter, the business model strives to correct two main loan market inefficiencies:

Limited Access: The current financial system allows only Banks and/or similar financial institutions to offer short or mid term financial loans, leaving aside individual investors (although part of this market is covered by low-yield short term bonds and Commercial Papers.) The essence of our model is to provide the means through which all investors can access this market, namely, our model is a Consumer to Business or Consumer to Consumer one (or in other words, Lenders to Borrowers).

High costs/low returns: The high financial spreads reflect both the banking operational costs as well as the loan portfolio performance. Our model will tackle both issues: On the one hand, operational costs will be significantly reduced thanks to cutting edge Internet technologies. On the other hand, the individual analysis of each operation and involved risk will allow the parties to price it effectively, without the burden and benefits of the bank's portfolio approach.

Our model will redistribute the financial spread, increasing Lenders' returns while reducing Borrowers' costs. The proportion and size of these gains will be ultimately dependent on the competition created by the model and the quality of the auctioned projects.

According to a preferred embodiment, our invention contemplates the creation of a trading arena and facilitate the process by combining Internet technology and a series of auxiliary services (the “Support Services”) to be provided by strategic partners. As such, the OLME is neither a Lender nor a Borrower. Access to this online marketplace will be universal.

In accordance with the preferred embodiment, the model features the presence of essential support services which are meant to help the parties analyze the underlying risks and close the deals. In all cases, they are optional. The main players will be:

a. Brokers

Could be professional loan brokers or ad-hoc brokers (such as accountants, lawyers or other corporate advisors). Their supporting role would consist in introducing and/or vouching projects presented by borrowers.

b. Credit Rating Companies and Personal Credit Rating Companies

These players will offer to Lenders and Guarantor alike credit information on borrowers. These reports could deal with risks previously analyzed by the Credit Rating Companies, or new risks altogether.

If the Borrower or the Guarantor, have a credit rating and they agree to display it, they will be able to allow the Lenders to view it.

The Lender, in turn, will be able to log in the Credit Rating Company website through a link and pay for an existing credit report or order a new one.

c. Personal referents

Borrowers will be encouraged to add personal credit recommendations from acquaintances, including suppliers, customers, partners, banks, other creditors, etc.

d. Insurance Companies

These players will offer insurance coverage packages on a case by case basis, either unsolicitedly or by request. Typical examples would be insurance on accounts receivable, fixed assets, patents, stockholder or key management life insurance, or principal repayment risk.

e. Guarantors

These players are reputable individuals or entities with an impeccable credit standing, who are willing to underwrite projects for a fee. Guarantors will offer their services to Lenders by posting their conditions on projects of their choice, provided that the Borrower authorized, upon insertion, the existence of a Guarantor.

Since the Guarantor will vouch for the Borrower, he will also have to comply with the same requirements them.

The arrangements between the Guarantor and the Lender will be private and will not involve the Borrower.

f. The Trustee

This player will perform a variety of duties on a national and eventually, international scale, including the following:

Registration of the parties, including signatures and empowerments for transaction closing.

Verification of Loan Documentation and compliance with precedent conditions, as established by borrowers and implicitly accepted by the winning lender.

Escrow arrangements based on “payment against delivery” mechanisms.

Ongoing collection and payment services.

Documentation custody services.

Preparation of feedback reports upon closing

g. Preferred Bank

This player will be responsible for handling the money transfers involved in each transaction.

h. Independent Credit Analysts

In addition to the Credit Rating Companies, the OLME will encourage the participation of Independent Credit Analysts. These players will analyze projects, whether solicitedly or unsolicitedly. Their resulting reports will be available online to the interested parties for a fee.

An affiliate program will be put in place with these players from day one and marketing actions will be specifically aimed at this group.

The Independent Credit Analysts will have their own popular track records, based on comments given by other parties on their historical performance and accuracy of reports.

i. Preferred Auditing firm

This player will perform special audits and due diligence upon specific lenders request.

j. Title Searchers and Registrars These players check and corroborate the authenticity of the titles offered as collateral by the Borrowers.

k. Preferred Legal Advisor

This player will provide the standard loan documentation through our website for optional use of the parties. Amendments to standard documents will be at a cost.

l. Preferred Mediation Services Agency

This player will offer mediation services to the parties in case of dispute. Standard documentation will by default appoint this agency.

The present embodiment contemplates the following main players:

Lenders and Borrowers

a. Lenders

While our site will be universal for all players alike, the Lenders will have a preponderant role. A key distinctive feature of our model lays in the fact that we shall actively promote the participation of quality individual lenders, beyond the traditional participants of the financial lending market. We strongly believe that given the adequate tools, there is a substantial investors' base to be drawn to our site. These participants will be motivated by a variety of factors, including the natural desire to obtain better returns, the gratification of handling their own decision making process, and in some cases, for risk-prone lenders, sheer speculation. The main profiles of the lenders will be as follows:

Individual Investors (II):

Mostly self-confident individuals over 30, with available funds, certain finance knowledge and computer/internet literacy, usually discretional stock investors. This group will be motivated by higher yields, novelty, challenge, bidding thrill, bargain hunting, etc.

Professional Corporate Investors (PCI)

Mainly Commercial Bankers, Credit unions, Savings institutions, Asset Based Lenders, Lessors and Lease finders, Factors, Mortgage Lenders. This group will be motivated by the possibility of syndicating transactions together with individual lenders, by the availability of information on potential clients and last but not least by the challenge of gaining access to the online business community through our channel.

b. Borrower's Profile

We identify three main types of borrowers:

Those with current access to finance from the traditional financial markets.

Those with enough collateral to attract investors.

Those with a weaker credit profile, such as start-up companies, under-capitalized or under-collaterilized ventures, etc.

Under the preferred embodiment of the present invention, our model will result in the following benefits for Borrowers:

Reduce borrowing cost particularly in short term transactions by generating competition using proven auction mechanisms such as the Dutch Auction.

Provide an alternative and far cheaper very short term finding mechanisms for top credits.

Develop an alternative and wide finding source (and to put pressure on banks to renegotiate terms)

For Public Borrowers, the possibility of offering a new product to their existing capital markets investors' base

Benchmark with similar risks.

For weaker credits, the possibility of accessing to investors in addition to banks.

According to the present embodiment the OLME website will have the following features and tools:

The website design will be friendly and clear. Our Site will be designed to reflect a very formal and sober environment to transpire confidence.

Our goal will be to minimize the surfers' learning time to use the sites features and tools. Having said this, there are special features that will have to be contemplated. These are:

i. The amount and diversity of the information to be provided by the Borrower on his project.

ii. The links to the supporting players.

iii. Online discussion forums

iv. A sophisticated tracking record.

v. Our model will feature additional players (apart from Borrowers and Lenders), such as the Guarantor.

vi. Loan Documenta

vii. Other Tools

a. Borrowers information

While the site will offer some guidelines and patterns, the Borrowers will be entitled to present their information on a discretional basis. Obviously, the quality and quantity of the disclosure offered by the Borrowers will determine to a great extent the success and cost of the transaction. The site will actively encourage the insertion of quality transactions through customer support units, online tutorials and marketing actions.

Note: Borrowers will be asked to certify the accuracy and validity of the information provided. If they do not, a warning sign will be displayed.

Borrowers and Guarantors will be entitled to an unlimited amount of storage space at no cost in our for uploading their information. The access to this information box will be regulated by the Borrowers and Guarantors. Additionally, Borrowers with Web pages will be encouraged to set up a direct link to their URL address.

The information of each transaction will be visible only to the parties determined by the Borrowers. By default, non-registered visitors will only be able to see transaction amounts, ratings and bidding activity.

Borrowers will be able to chose between four presentation strategies. The first will be to base the presentation on the quality and market recognition of the Borrower (Name Lending). The second one will be based on the credit rating or financial position of the borrower (Rating Lending). The third will be based on the collateral offered (Collateral Lending) and the fourth will be based on the credit information directly provided by the Borrower (Credit Lending) Needless to say, the second, third and fourth options could include the borrower's name as per his own discretion.

b. Links to access third party information

Credit Rating Companies and Personal Referees

Should the borrower have a valuable credit rating, he can opt for a variety of options, such as allowing full access to the rating report or access only to the rating results or even, in a no-name auction, to delete any identificatory marks on the report.

Referents

Should the Borrower have a well known and respectable supplier, customer, partner or similar willing to vouch for his credit record, he can to:

Upload and display the Introductory Letter.

Insert the referent's e-mail address or telephone. In this case our systems will provide connectivity via email or dial-up.

c. Online Discussion Forum

Each project will generate its own Online Discussion Forum, where Registered Lenders will be invited to provide constructive criticism.

d. Our tracking record mechanism

Differently from the Popular Track record schemes widely used in most auction sites, ours will feature two stages. The first one will include comments on the post-auction negotiation and loan closing, and the second, information on the debt repayment itself Given enough time, this mechanism will be a valuable credit assessment tool.

All acting parties will develop a Track Record. Since some parties will be able to act in different roles (Lender, Borrower or Guarantor), the different Track Records of a player will be displayed together.

e. Documentation

In order to reduce the negotiation time and concentrate the auction process in Risk assessment and bidding, a standard set of documents will be made available to the Borrower. He will be able to either:

Accept it.

Accept it partially and upload amendments

Reject it and upload his own loan documentation.

Precedent conditions, Representations, Covenants, Events of Default and other standard legal loan provisions: Similarly to the Documentation, the borrower will be able to accept or amend a standard set and these will vary depending on the type of transaction to be executed.

Customer support

Our model contemplates a highly skilled and specialized customer support team to meet the professional requirements of financial auctions. The emphasis will be placed on the insertion process to ensure high success rates. At a later stage, premium customer support will be available for key players.

Communication: Given the natural complexity of the items auctioned, Lenders will be allowed to post questions on the Borrowers Auction page. Borrowers, should they decide to answer, will do so in the same way.

Links to Information Sources: Special links will be made available to the parties in order to:

Access to industry and sector information

Access to news clipping services.

Access to scoring and simulation programs.

Access to information regarding the credit and interest rates markets.

Loan calculator and financial formulae

Historical Auctions Interest rates curves and graphs

Browsing:

Lenders will be able to access auctions through different routes, including the following:

Loan type

Maximum interest rate

Rating

Guarantees

Track Record

Name or no name lending

Loan Amount

Tenor

Additionally, commercial categories like the following will be featured:

Hot

Closing today

New today

Best rating

In accordance with the preferred embodiment, the registration process will be follows: In order to operate, the various parties (Lenders, Borrowers and Guarantors) will be required to sign up to our website. Sufficient proof of identity and empowerment will have to be provided. Registration will be free of charge. General visitors will be able to browse through our site and visualize a limited amount of information as per the Borrowers' discretion.

While our site will not be liable for the quality of the information provided by the registrants, we shall do our utmost efforts in order to ensure its authenticity and bona fides. For instance, our site will conduct thorough checks (using the services of Equifax or equivalent companies, Social Security Number, Chapter XI and Chapter VII files, etc.) in order to validate the information provided and to avoid the insertion of misleading homonyms. Having said so, the parties will be constantly reminded to perform their due diligences. Upon registration, the parties will fully accept the site's terms and conditions and indemnity clauses and the binding nature of Borrowers' insertions and Lenders' bids.

Unless the Borrower decides to disclose his name, the identities of Lenders and Borrowers alike will remain unknown until the auction is closed.

A Premium Service will be offered to Borrowers interested in offering their projects within a closed environment made up of selected Lenders picked up by the former upon insertion.

b. Insertion

Once registered, the Borrower can proceed to insert its project for auction. This process is divided into several stages. The insertion is binding, therefore the Borrower is contractually obliged to accept the finance provided by the auction winner. In order to avoid problems, the Borrower can define upon insertion the profile types of Lenders he is not interested in receiving loans from. Insertions can be modified before the first bid is placed, provided that the modifications are not related to the auction terms as a whole. Once inserted, projects will go through the auction until it expires. Insertions of over U$S 5,000,000.- projects will require our prior approval to avoid reputation risks.

Definitions: The Borrower will have to establish his position vis a vis the following items:

Name disclosure

Rating disclosure

Use of proceeds and repayment source

Collaterals

References

Credit information to be made available

Insertion type (normal featured, etc.)

Maximum interest rate

Interest rate type (fixed or variable)

If variable, what base rate (Prime or LIBOR)

Loan amount

Amortization schedule

Interest payments

Closing and disbursement date

Documentation

Preferred trustee

Acceptable Lenders: with or without track record, with or without guarantor.

Minimum Precedent conditions: Unless expanded by the Borrower upon insertion, the Minimum Precedent Conditions for a loan closing will be the following:

All the documentation displayed by the Borrower in our site, has to be delivered in originals upon the notification of the winning bid.

Borrower has to declare that no material changes on his financial situation and credit worthiness have occurred in relation to the presented project documentation.

Borrower has to attest that to the best of his knowledge, there are no other impediments for the loan to be timely repaid that no material information has been withheld to the detriment of the Lender.

In case of corporate Borrowers, originals of the corporate By Laws need to be delivered.

Borrower has to certify his empowerment to sign on behalf of his corporation including signature specimens or alternative means of signature certification.

Delivery of properly signed loan documentation and disbursement instructions.

(All these conditions are subject to legal advice)

c. Auction terms:

The Borrower will have to decide on:

Maximum interest rate

Auction duration (between hours and 10 days)

Auction types

There will be the following auction types:

Bulk: The loan amount to be auctioned is not divisible and is treated as a single item.

Split: The loan amount to be auctioned is divided in pre-defined lots by the Borrower upon insertion. If the total amount is not met, the Auction is cancelled.

English (bulk or split): Bids are sorted by rate, amounts and time of insertion. In bulk auctions, the earliest lowest rates win the auction. In split auctions, the same criteria apply, but the lots are allocated by rate and amount until the total auction amount is met. Each lot will be allocated with its own bidding rate.

Dutch: This type of auction is split only. Unlike the English split type, in this case, all of the winning lots receive the interest rate of the last winning bid.

Visible or Sealed Bid auctions: Visible auctions allow all the bidders to see the unfolding of the auction, including others bids, the interest rate to beat the nicknames of the other bidders, and the time of the bids insertions. On the other hand, Sealed Bid auctions only show the number of bids received.

d. Interest Rates

To standardize the process, all quoted rates will be done on an annual effective basis, calculated on a 30/360 days basis. Additionally, standard interest formulas will be applied in the transactions. This will be visible to all parties on the site. The interest rate risk arising from the time elapsed between the Auction closing and the disbursement will be borne by the parties.

Maximum interest rate: This is the rate above which the bids are not accepted.

Bidding rates: These are the rates quoted by the Lenders. In order to be acceptable, bids have to be in decrements of 1 basis points.

Winning rate: Will be the lowest rate (or rates in the case of split auctions) at the closing time of the auction.

e. Auction duration

In order to enable Lenders to fully assess the risks involved in a certain auction and to fix an interest rate accordingly, the site will initially recommend the Borrowers to set the duration of an Auction at a minimum of 10 days.

The “5 minute rule” will apply, thus the auction will end only 5 minutes after the last bid was received.

f. Bidding

Upon reviewing and selecting the auctions of interest the bidder will download all the relevant auction material and perform his own credit analysis. Should the bidder have questions, he will be able to place them in a special board on the same auction page. The Lender will have the option to answer it. If he does, both question and answer will be visible for all parties.

No direct communication between the parties will be allowed.

As a safety feature, our system will provide an online credit checklist for Lenders to be displayed before they enter their bid.

Once the bid is placed, it is binding and irrevocable. The closing of the winning bid/s will only be subject to the fulfillment of the precedent conditions. The Borrower will not be entitled to reject the winning bid unless it does not meet his insertion criteria. Our software will feature a series of warnings and alarms to make sure the bidder does not enter mistaken bids.

In order to encourage the participation of Lenders with no track record, our site will offer a free of charge “No Closing” insurance coverage for Borrowers. This insurance package will cover those cases in which a first time Lender does not close a winning bid for reasons other than the precedent conditions of the auction. The insurance compensation will be about 1% of the loan principal amount (pro-rata temporis on an annual basis).

g. Closing

Once a winning bid is declared, the site will inform the result via email the Borrower and winning Lender/s respectively. If the site's preferred trustee has been chosen, he will also be notified. The parties will have to execute the transaction within the parameters established by the Borrower upon insertion or within 30 days from the date of our notification, the earliest.

Upon closing, the parties will be entitled to report comments on the other parties performance, and this information will become part of the parties track record.

As a matter of policy, our site will strongly recommend the players to use either our Preferred Trustee of their own Trustee, in order to expedite the closing of the operation.

h. Confidentiality

Our site will guarantee strict confidentiality of the information received from the different players, to ensure compliance with the following:

Access and visibility only to authorized parties.

Safeguarding the information stored on the memory space provided to the parties.

No use of the information given to us in confidence for purposes different from the ones relevant to the auction itself.

Upon registration, all the parties commit themselves to the Confidentiality clauses detailed on the Site's Term and Conditions, i.e., to respect the proprietary nature of the information displayed and to use it only for the Auction's purposes.

Additionally, in the case of Premium Auctions, the Borrower will have the option to require specially invited Lenders to sign a non-disclosure agreement.

In accordance with the preferred embodiment of our invention, the target borrowing markets will be:

a. Corporate Borrowers: These high quality Borrowers who have access to bank credit lines will find in our site a valuable tool to reduce their financial cost while developing an alternative financing source. At the same time, Borrowers will be able to develop a short term debt investor base.

b. Collaterals: Similarly to Short Term Credits, Collaterals will be key to entice our Individual Lenders' base. Particular attention will be given to Asset Finance, Commercial Mortgages, Asset Based Lending and other popular forms of collateral lending.

c. Short Term Credits: Given our model's new approach to credit and the individual nature of our investor's base, we believe short term transactions will be the most popular type of loan.

d. No-Consumer Credit: Although our model does not discard the Consumer credit market, it seeks to move one step higher in the credit ladder and tackle transactions of at least US$200,000 generated by small to medium size corporations.

e. Primary Market: Initially, our model will focus on the Primary Market where we believe the highest cost reduction is possible and the best transactions are likely to appear. At a later stage, we shall develop our secondary market section, through which, transactions originally generated in our site as well as in others, will be transacted.

f Private: Without discarding the public debt issuance market, we believe that the private market will enable us to create the highest savings for the parties at an initial stage.

In accordance to other embodiments, our invention contemplates the development of the following concepts

i. Service related:

Secondary market: Once our lender base will be ready to interact with this market we shall become an important venue for transacting loan assignments of all qualities, including default loans, whether originated in their primary round within or without the OLME.

Currency exchange and swaps: Once our model becomes reputable in the major foreign markets (London, Frankfurt Tokyo and Hong Kong) and we develop a client base in those markets, it will be fairly easy for us to expand our business into a double auction FX exchange.

Ecological Credits: We shall create special auction spaces designed to meet the specific criteria of selected groups of Lenders. Such spaces could be devoted for Islamic finance, green loan, non-belic loans, third world aid loans, etc.

City and similar public debt financing: Similarly to the ecological credits, our model will be ideal for placing public debt among individuals, thus strengthening the bond between the city and its community.

Automatic response Loans for small and middle sizes companies: In this development we shall apply existing and proven technologies to reduce the credit assessment of loans up to U$S 50,000 to seconds, enabling very fast auctions.

Credit Card Financing: Once the lenders market has gained size and depth, it will be possible for us to develop a system whereby purchases done by credit card can generate an automatic insertion and auction in our site.

Investment Clubs and Funds: While we shall not actively participate in such institutions, we will actively promote the creation of private investors clubs and funds, especially aimed at the types of loans auctioned by us.

Interest Rate lock-in: This service will be offered by third parties for Borrowers or Lenders who wish to lock-in their interest rates.

Frequent users: One-step mechanisms will be implemented for frequent users based on the information available in our system.

b. Marketing related

Links Finance-It: We shall create alliances with selected equipment manufacturers whereby buyers will have the option to enter the details of their purchase and link up with our site to auction their financing needs, offered the purchased equipment as collateral.

Links with Asset managers: Whenever possible, we shall set up alliances with non-competing Asset Managers through which mutual customers will benefit from fast link features to access our auctions arena.

c. Complementary services

Pop up menus: with suggestions and translations.

d. Technology related

Digital signature: Once this technology becomes widely accepted, it will be offered to our clients who will still keep the option of working with ink signatures and Promissory Notes.

The preferred embodiment of our invention contemplates three well defined revenue sources: (i) Auction fees, (ii) Income sharing schemes with Support Services Providers, and (iii) other sources (such as advertising, e-commerce sharing schemes, etc.).

The Borrower will bear all the auction costs, namely the Insertion Fee and the eventual Success Fee.

Our fees will be low to entice the participation of all type of borrowers. The Success Fees are contingent and they bear a relationship with the value created by the auction.

Insertion Fees: They are fully deductible from the Success Fees. They will vary according to several parameters:

Loan amount.

Auction type (Open, closed, Dutch, etc.). The insertion fee will be proportional to the restrictions imposed on the auction scope.

Presentation format (Featured, hot etc.) These extras have not been included in our Financial Projections.

Our expected Average Insertion Fee will be US$100, a number high enough to discourage non serious Borrowers.

Success Fee

This fee will bear a direct relationship with the added value to the parties in terms of yield/saving and access. It will also depend on the amount and tenor of the loan transaction. The added value will be measured as the difference between the Maximum Interest Rate as defined by the Borrower upon insertion and the final Interest Rate as per the winning bid.

Reinsertion Fee

If the auction fails (i.e., there are no bids below the maximum interest rate at the closing time), then the Borrower will be entitled to re-insert his project with no charge, provided he improves at least one of the following parameters:

Collateral.

Higher Maximum Interest Rate.

Reduce tenor.

Reduced amount.

Roll Over Policy

Maturing transactions will be monitored by the site and Borrowers will be invited to insert a new project, upon maturity, to refinance the previous loan at no cost.

b) Fee sharing Schemes with Support Services:

Credit Rating Companies and Personal Credit Rating Companies

We will negotiate a profit sharing scheme with these companies in order to get recognition from:

Introduction of new clients (i.e., new reports).

Visualization of reports.

Our model contemplates a rebate per report and a rebate per report visualization.

Independent Credit Analysts

We will charge a minimum insertion fee plus a fee per report visualization.

Guarantor

Guarantors will pay a non-refundable flat insertion fee and will not pay success fees.

Trustee

Our model contemplates a rebate per account opened and fee-per executed transaction.

Preferred Bank

Our model contemplates a rebate per account opened plus a fee per money transfer.

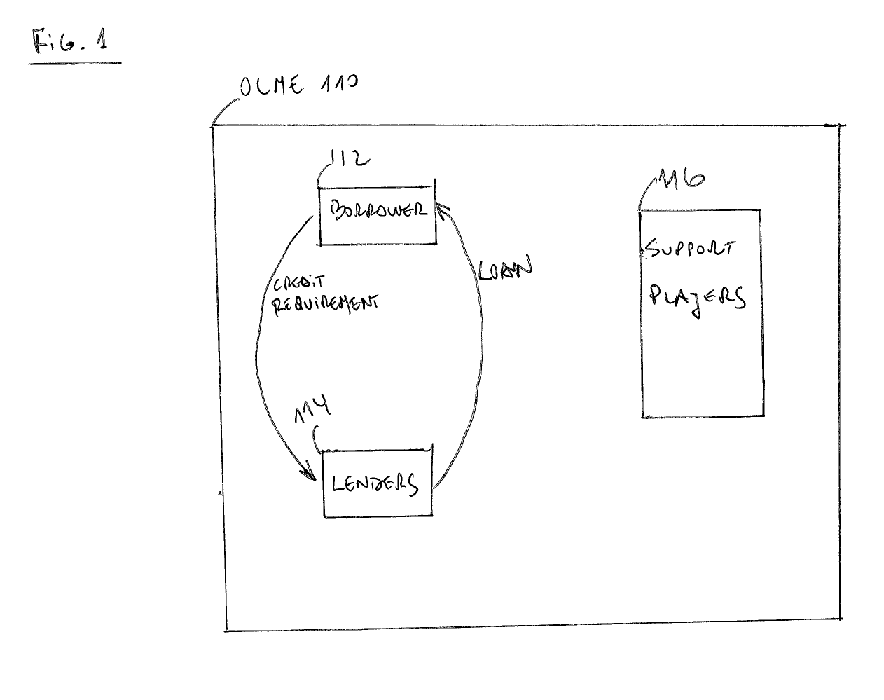

FIG. 1 is a system diagram depicting relationships between various aspects of the On-line Market Environment 110 (OLME). The Borrower 112 presents his credit requirements for the consideration of the Lenders 114 who will analyze the project and will bid amongst them. All this process may be supported by the Support Players 116 (credit rating companies and personal credit rating companies, personal referents, guarantors, independent credit analysts, the trustee, brokers, insurance companies, preferred bank, preferred auditing firm, title searchers and registrars, preferred legal advisor, preferred mediation services).

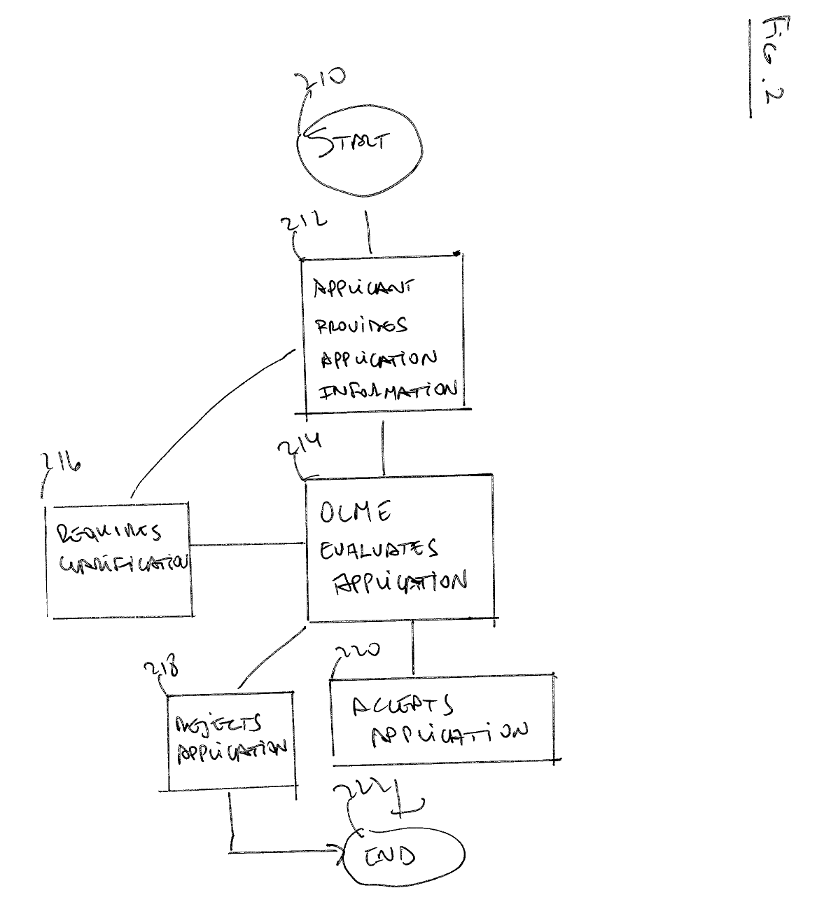

FIG. 2 is a flowchart of an exemplary method of registering with OLME. The method starts in step 210 and proceeds to step 212 where the applicant (borrower, lender or guarantor) provides relevant application information, including empowerement, to register with OLME.

OLME evaluates the application 214 and either requires clarifications 216 (in which case, the process goes back to 212), rejects it as per step 218 (in which case the process goes to end 222) or accepts it as per step 220 and goes to end step 222.

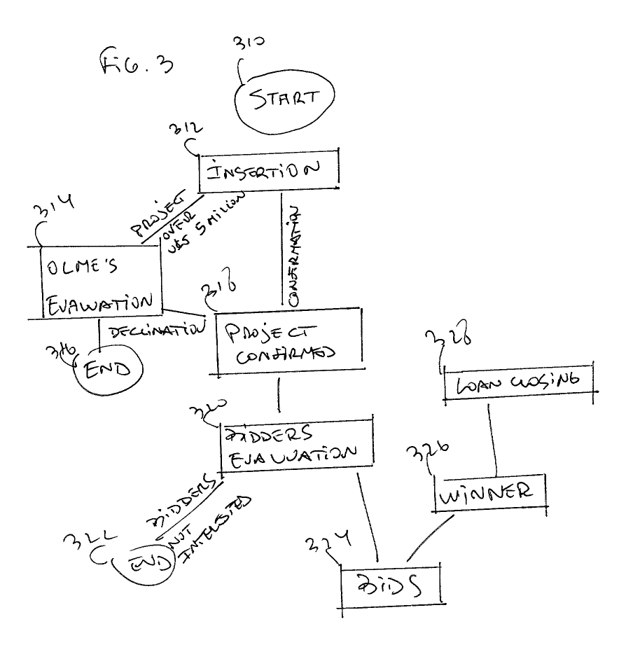

FIG. 3 is a flowchart of an exemplary method of the auction process. The process starts in step 310 and goes to the insertion 312 of the project by the borrower. The insertion includes a detail of the auction terms:

Auction type: whether the loan is bulk or split, English or Dutch.

The loan duration.

The auction's interest rates, maximum interest rates

The information and the support players provided by the borrower.

Any banned lender.

All the relevant information is uploaded onto the site for review by the Lenders.

If the project is over 5 M U$S, then it goes to step 312 for OLME's acceptance and from there it can go to the negative branch 314 if OLME declines the project in which case the process goes to end 316, and the project is aborted, or to the positive branch 318 if OLME confirms the auction. From step 318 or from step 312, the process goes to step 320 which represents the Bidders' Evaluation. Those bidders who are not interested go to end 322. Those interested, proceed with their bids 324 and the winning bid 326 goes to the closing of the loan 328.

What is claimed is:

1. A method of creating a Web based community of reverse credit auctions in which the borrowers present their credit needs and collaterals and the lenders analyze those projects on a caveat emptor basis and compete through the interest rates.

2. The method of claim 1., wherein the Lenders are individual investors.

3. The method of claim 1., wherein the Lenders are Professional Investors.

4. The method of claim 1., wherein the borrowers are those with access to finance from the traditional non collateralized financial markets, or those with current access to the traditional Asset Based Financial Market or those with a weaker credit profile, such as start-up companies, under-capitalized or under collateralized ventures.

5. The method of claim 1., wherein there are one or more support players, such as: Credit Rating Companies and Personal Credit Rating companies, Personal referents, Guarantors, Independent Credit Analysts, Trustees, Brokers, Insurance Companies, Preferred Banks, Preferred Auditing Firm, Title Searchers and Registrars, Preferred Legal Advisor, Preferred Mediation Services.

6. The method of claim 1., wherein the auction is Dutch

7. The method of claim 1 wherein the auction is English.

8. The method of claim 1 wherein the auction is split

9. The method of claim 1. wherein the auction is bulk.

10. The method of claim 1., wherein the revenue sources are (i) Auction fees, (ii) Income sharing schemes with Support Services Providers, and (iii) other sources (such as advertising, e-commerce sharing schemes, etc.).

11. The method of claim 1., wherein the borrowers will pertain to the Secondary Market.

12. The method of claim 1., wherein the loans will fall in the category of Ecological Credits, such as Islamic finance, green loan, non-belic loans, third world aid loans, etc.

13. The method of claim 1., wherein the loans will fall in the category of City and similar public debt financing: Similarly to the ecological credits, our model will be ideal for placing public debt among individuals, thus strengthening the bond between the city and its community.

14. The method of claim 1, wherein the loans will be designed for Credit Card Financing: i.e., the Lenders will compete amongst them to lend money to cardholders within a system whereby purchases done by credit card can generate an automatic insertion and auction in our site.

15. The method of claim 1., wherein the OLME becomes an arena for a double auction foreign currencies exchange.
